(19) United States
(12) Patent Application Publication
(10) Pub. No.: US 2025/0340257 A1
(43) Pub. Date: Nov. 6, 2025

(54) TRACK SYSTEM AND WHEEL ASSEMBLIES FOR TRACK SYSTEMS

(71) Applicant: SOUCY INTERNATIONAL INC., Drummondville (CA)

(72) Inventors: Jeremie AUBIN-MARCHAND, St-Hugues (CA); Yan ROGER, Drummondville (CA); Gabriel LANDRY, Saint-Mathieu-de-Laprairie (CA); Styve ALLIE, Drummondville (CA)

(21) Appl. No.: 19/200,315

(22) Filed: May 6, 2025

Related U.S. Application Data
(60) Provisional application No. 63/643,210, filed on May 6, 2024.

(51) Int. Cl. B62D 55/084; B62D 55/065; B62D 55/10; B62D 55/104; B62D 55/125; B62D 55/14; B62D 55/24

(52) U.S. Cl. CPC B62D 55/084; B62D 55/10; B62D 55/104; B62D 55/125; B62D 55/14; B62D 55/244; B62D 55/065

(57) ABSTRACT

Track system includes a frame defining first and second lateral sides, wheel assemblies, and an endless track. A drive wheel assembly rotatable about a drive wheel axis includes a drive wheel defining a drive wheel diameter. Front and rear idler wheel assemblies each have two laterally spaced wheels defining front and rear idler wheel diameters similar to the drive wheel diameter. Support wheel assemblies include first and second tandem wheel assemblies disposed, respectively, on the first and second lateral sides, and each having two longitudinally spaced support wheels offset from the drive wheel axis, and a rear support wheel assembly including two laterally spaced support wheels. On a hard flat surface, in one configuration, bottoms of the six support wheels, and bottoms of the wheels of the front idler wheel assembly are vertically aligned, and are vertically lower than bottoms of the wheels of the rear idler wheel assembly.

### CROSS-REFERENCE TO RELATED APPLICATION

The present application claims priority to U.S. Provisional Patent Application No. 63/643,210, filed May 6, 2024 entitled “Track System and Wheel Assemblies for Track Systems”, which is incorporated by reference herein in its entirety.

### TECHNICAL FIELD

The present application generally relates to track systems. More specifically, the present technology relates to layouts for track systems, wheel assemblies for track systems, resiliently pivoting idler wheel assemblies, and wheels with conical wheels.

### BACKGROUND

Track systems are conventionally used with various types of vehicles such as agricultural vehicles, construction vehicles and recreational vehicles.

Conventional track systems do, however, present some inconveniences. Conventional track systems generally have to be replaced and/or modified depending on the season in which they are used. For example, some conventional track systems optimized for use in winter (e.g., operated on snow) may not be suitable for use in summer (e.g., operated on hot asphalt). Using conventional track systems on surfaces that the conventional track systems are not optimized for may result in premature wear of various components of the track systems and/or negatively impact performance of the track systems (e.g., increase rolling resistance).

Additionally, when overcoming obstacles or while travelling over bumpy terrain, conventional track systems can transfer vibrations and shocks to a driver and/or to the passenger, thereby negatively impacting ride quality.

Furthermore, some conventional track systems may use wider wheels to better distribute load, but this may cause an increase of ingestion of debris within the endless track.

Therefore, there is a desire for a track system that could mitigate the above-mentioned issues.

### SUMMARY

It is an object of the present technology to ameliorate at least some of the inconveniences present in the prior art.

According to one aspect of the present technology, there is provided a track system for a vehicle. The track system includes a frame, a drive wheel assembly, front and rear idler wheel assemblies, a plurality of support wheel assemblies and an endless track. The frame defines a first lateral side and a second lateral side. The drive wheel assembly is rotationally connected to the frame, and is rotatable about a drive wheel axis, The drive wheel assembly includes a drive wheel defining a drive wheel diameter. The front idler wheel assembly is rotationally connected to the frame, and has two laterally spaced wheels. Each one of the two laterally spaced wheels is disposed on either lateral side of the frame, and each one of the two laterally spaced wheels defines a front idler wheel diameter. The rear idler wheel assembly is rotationally connected to the frame, and has two laterally spaced wheels. Each one of the two laterally spaced wheels is disposed on either lateral side of the frame, and each one of the two laterally spaced wheels defines a rear idler wheel diameter. The plurality of support wheel assemblies includes a first tandem wheel assembly, a second tandem wheel assembly, and a rear support wheel assembly. The first tandem wheel assembly is pivotally connected to the frame, and is disposed on the first lateral side of the frame. The first tandem wheel assembly includes a first support wheel and a second support wheel. The first support wheel is disposed at least partially longitudinally forward from the drive wheel axis, and the second support wheel is disposed at least partially longitudinally rearward from the drive wheel axis. The second tandem wheel assembly is pivotally connected to the frame, and is disposed on the second lateral side of the frame. The second tandem wheel assembly includes a third support wheel and a fourth support wheel. The third support wheel is disposed at least partially longitudinally forward from the drive wheel axis, and the fourth support wheel being disposed at least partially longitudinally rearward form the drive wheel axis. The rear support wheel assembly is rotationally connected to the frame, and has a fifth support wheel and a sixth support wheel. The fifth support wheel is disposed on the first lateral side of the frame, and the sixth support wheel is disposed on the second lateral side of the frame. The endless track surrounds the frame, the drive wheel assembly, the front idler wheel assembly, the rear idler wheel assembly, and the plurality of support wheel assemblies. The drive wheel diameter, the front idler wheel diameter and the rear idler wheel diameter are generally similar. With the track system being in a first configuration on a hard flat level surface, a bottom of the first support wheel, a bottom of the second support wheel, a bottom of the third support wheel, a bottom of the fourth support wheel, a bottom of the fifth support wheel, a bottom of the sixth support wheel, and bottoms of the laterally spaced wheels of the front idler wheel assembly are generally vertically aligned. Additionally, bottoms of the laterally spaced wheels of the rear idler wheel assembly are vertically higher than the bottom of the first support wheel, the bottom of the second support wheel, the bottom of the third support wheel, the bottom of the fourth support wheel, the bottom of the fifth support wheel, the bottom of the sixth support wheel, and the bottoms of the laterally spaced wheels of the front idler wheel assembly.

In some embodiments, with the track system being in the first configuration on the hard flat level surface, the track system has a first contact patch. A length of the first contact patch generally extends between the bottoms of the fifth and sixth support wheels and the bottoms of the laterally spaced wheels of the front idler wheel assembly. The length of the first contact patch is one side of a triangle, the triangle being defined between the bottom of the laterally spaced wheels of the front idler wheel assembly, the bottom of the fifth and sixth support wheels of the rear support wheel assembly, and a top of the drive wheel assembly.

In some embodiments, the top of the drive wheel assembly is generally longitudinally centered between the bottom of the laterally spaced wheels of the front idler wheel assembly and the bottom of the fifth and sixth support wheels of the rear support wheel assembly.

In some embodiments, with the track system being in the first configuration on the hard flat level surface, the track system has a departure angle defined between the hard flat level surface and a section of the endless track, the section of the endless track extending generally parallel to a line extending between the bottom of the laterally spaced wheels of the rear idler wheel assembly and the bottom of the laterally spaced wheels of the rear support wheel assembly.

In some embodiments, in response to the track system encountering an obstacle, the track system is pivotable about the rear support wheel assembly to a second configuration, in which the bottoms of the laterally spaced wheels of the rear idler wheel assembly are vertically aligned with the bottoms of the fifth and sixth wheels of the rear support wheel assembly. Additionally, the bottom of the first support wheel, the bottom of the second support wheel, the bottom of the third support wheel, the bottom of the fourth support wheel and the bottoms of the laterally spaced wheels of the front idler wheel assembly are vertically higher than the bottoms of the laterally spaced wheels of the rear idler wheel assembly and the bottoms of the fifth and sixth wheels of the rear support wheel assembly.

In some embodiments, with the track system being in the second configuration, the track system has an approach angle defined between the hard flat level surface and a section of the endless track, the section of the endless track extending generally parallel to a line extending between the bottoms of the fifth and sixth wheels of the rear support wheel assembly and the laterally spaced wheels of the front idler wheel assembly.

In some embodiments, at least one of the front idler wheel assembly and the rear idler wheel assembly is resiliently pivotable with respect to the frame about a longitudinal axis, such that in response to the at least one of the front idler wheel assembly and the rear idler wheel assembly being offset from a given position, the at least one of the front idler wheel assembly and the rear idler wheel assembly being biased toward the given position.

In some embodiments, the front idler wheel diameter is equal to the rear idler wheel diameter.

In some embodiments, a ratio between one of the front idler wheel diameter and the rear idler wheel diameter over the drive wheel diameter is between about 0.8 and 1.2.

In some embodiments, the endless track defines a first radius of curvature around the drive wheel assembly, a second radius of curvature around the front idler wheel assembly, and a third radius of curvature around the rear idler wheel assembly. The first radius of curvature, the second radius of curvature and the third radius of curvature are generally similar.

In some embodiments, at least one of the two laterally spaced wheels of the rear idler wheel assembly is a conical wheel.

In some embodiments, the first tandem wheel assembly and the second tandem wheel assemblies are asymmetrical.

In some embodiments, the first support wheel and the second support wheel are longitudinally spaced by a first distance, the third support wheel and the fourth support wheel are longitudinally spaced by a second distance, and the first distance is greater than the second distance.

In some embodiments, the first tandem wheel assembly and the second tandem wheel assembly are at least indirectly connected to one another via a shaft, and the first tandem wheel assembly and the second tandem wheel assembly are pivotable about the shaft.

In some embodiments, the frame defines first and second apertures. The first aperture is configured to receive a shaft of the front idler wheel assembly. The second aperture is vertically spaced from the first aperture, is configured to receive a shaft of an alternative front idler wheel assembly, the front alternative wheel assembly including two laterally spaced wheels, each one of the two laterally spaced wheels defining an alternative front idler wheel diameter, the alternative front idler wheel diameter being smaller than the front idler wheel diameter.

In some embodiments, the track system is an all-season track system.

In some embodiments, the track system is configured to connect to one of a 4×4 vehicle, and a 6×6 vehicle.

According to another aspect of the present technology, there is provided a track system for a vehicle. The track system includes a frame, a drive wheel assembly rotationally connected to the frame, at least one idler wheel assembly rotationally connected to the frame, a plurality of support wheel assemblies rotationally connected to the frame and an endless track surrounding the drive wheel assembly, the at least one idler wheel assembly and the plurality of support wheel assemblies. The at least one idler wheel assembly is pivotably connected to the frame, and is pivotable about a longitudinal axis.

In some embodiments, with the track system being in a first configuration on a hard flat level surface, in which the frame has a camber angle offset from zero degrees, the at least one idler wheel assembly is pivotable relative to the frame so that a rotation axis of the at least one idler wheel assembly is generally parallel to the hard flat level surface.

In some embodiments, the track system further includes a resilient member operatively connected to the at least one idler wheel assembly for biasing the at least one idler wheel assembly toward a given position.

In some embodiments, the drive wheel assembly has a drive wheel defining a drive wheel diameter, the at least one idler wheel assembly has a wheel defining an idler wheel diameter, and the idler wheel diameter being generally similar to the drive wheel diameter.

In some embodiments, a ratio between the idler wheel diameter over the drive wheel diameter is between about 0.8 and 1.2.

In some embodiments, a wheel of the at least one idler wheel assembly is a conical wheel.

In some embodiments, the plurality of support wheel assemblies include a first tandem wheel assembly disposed on a first side of the frame, and a second tandem wheel assembly disposed on a second side of the frame.

In some embodiments, the first tandem wheel assembly and the second tandem wheel assemblies are asymmetrical.

In some embodiments, the first tandem wheel assembly and the second tandem wheel assembly are at least indirectly connected to one another via a shaft, and the first tandem wheel assembly and the second tandem wheel assembly are pivotable about the shaft.

In some embodiments, the frame defines a first aperture and a second aperture vertically spaced from the first aperture. The first aperture is configured to receive a shaft of the at least one idler wheel assembly. The second aperture is configured to receive a shaft of an alternative idler wheel assembly, the alternative wheel assembly including a wheel defining an alternative idler wheel diameter, the alternative idler wheel diameter being smaller than the idler wheel diameter.

In some embodiments, the at least one idler wheel assembly is a front idler wheel assembly.

In some embodiments, the at least one idler wheel assembly includes a front idler wheel assembly and a rear idler wheel assembly.

In some embodiments, the track system is an all-season track system.

According to another aspect of the present technology, there is provided a track system for a vehicle. The track system includes a frame, a drive wheel assembly rotationally connected to the frame, a plurality of support wheel assemblies rotationally connected to the frame, a rear idler wheel assembly rotationally connected to the frame, and an endless track surrounding the drive wheel assembly, the plurality of support wheel assemblies and the rear idler wheel assembly. The rear idler wheel assembly includes at least one conical wheel.

In some embodiments, the rear idler wheel assembly is pivotable relative to the frame about a longitudinal axis.

In some embodiments, the rear idler wheel assembly further includes a resilient member operatively connected to the rear idler wheel assembly for biasing the rear wheel assembly toward a given position.

In some embodiments, with the track system being in a first configuration on a hard flat level surface, in which the frame has a camber angle offset from zero degrees, the rear idler wheel assembly is pivotable relative to the frame so that a rotation axis of the rear idler wheel assembly is generally parallel to the hard flat level surface.

In some embodiments, the drive wheel assembly has a drive wheel defining a drive wheel diameter, the rear idler wheel assembly has a wheel defining an idler wheel diameter, and the idler wheel diameter is generally similar to the drive wheel diameter.

In some embodiments, a ratio between the idler wheel diameter over the drive wheel diameter is between about 0.8 and 1.2.

In some embodiments, a wheel of the rear idler wheel assembly is a conical wheel.

In some embodiments, the plurality of support wheel assemblies includes a first tandem wheel assembly disposed on a first side of the frame, and a second tandem wheel assembly disposed on a second side of the frame.

In some embodiments, the first tandem wheel assembly and the second tandem wheel assemblies are asymmetrical.

In some embodiments, the first tandem wheel assembly and the second tandem wheel assembly are at least indirectly connected to one another via a shaft, and the first tandem wheel assembly and the second tandem wheel assembly are pivotable about the shaft.

In some embodiments, the track system is an all-season track system.

According to another aspect of the present technology, there is provided a track system for a vehicle. The track system includes a frame, a drive wheel, a plurality of support wheel assemblies, and an endless track. The drive wheel assembly is rotationally connected to the frame, and is rotatable about a drive wheel axis. The plurality of support wheel assemblies is rotationally connected to the frame, and includes first and second tandem wheel assemblies, both of which are pivotally connected to the frame. The first tandem wheel assembly is disposed on one lateral side of the frame, and includes first and second support wheels. The first support wheel is disposed at least partially longitudinally forward from the drive wheel axis, and the second support wheel is disposed at least partially longitudinally rearward from the drive wheel axis. The second tandem wheel assembly is disposed on an other lateral side of the frame, and includes third and fourth support wheels. The third support wheel is disposed at least partially longitudinally forward from the drive wheel axis, and the fourth support wheel is disposed at least partially longitudinally rearward from the drive wheel axis. The endless track surrounds the drive wheel assembly and the plurality of support wheel assemblies.

In some embodiments, the first tandem wheel assembly and the second tandem wheel assemblies are asymmetrical.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of an all-terrain vehicle with track systems according to embodiments of the present technology;

FIG. 2 is a perspective view taken from a top, rear, right side of a rear right track system of the all-terrain vehicle of FIG. 1;

FIG. 3 is a right side elevation view of the rear track system of FIG. 2, with part of a front idler wheel assembly of the rear track system being omitted;

FIG. 4 is a perspective view taken from a bottom, right side of the rear track system of FIG. 2, with an endless track of the rear track system being omitted;

FIG. 5 is a bottom plan view of the rear track system of FIG. 2, with the endless track of the rear track system being omitted;

FIG. 6 is a perspective view taken from a top, rear, right side of the rear track system of FIG. 2 with the endless track and part of a front idler wheel assembly being omitted;

FIG. 7 is a perspective view taken from a top, rear, right side of support wheel assemblies of the rear track system of FIG. 2;

FIG. 8A is a right side elevation of the rear track system of FIG. 2 in a first configuration;

FIG. 8B is a right side elevation of the rear track system of FIG. 2 in a second configuration;

FIG. 9 is a conventional track system as known in the art;

FIG. 10A is a schematic depiction of a conventional track system connected to a vehicle with a camber angle;

FIG. 10B is a schematic depiction of the track system of FIG. 2 connected to a vehicle with a camber angle; and

FIG. 11 is a right side elevation view of an alternative embodiment of the present technology.

### DETAILED DESCRIPTION

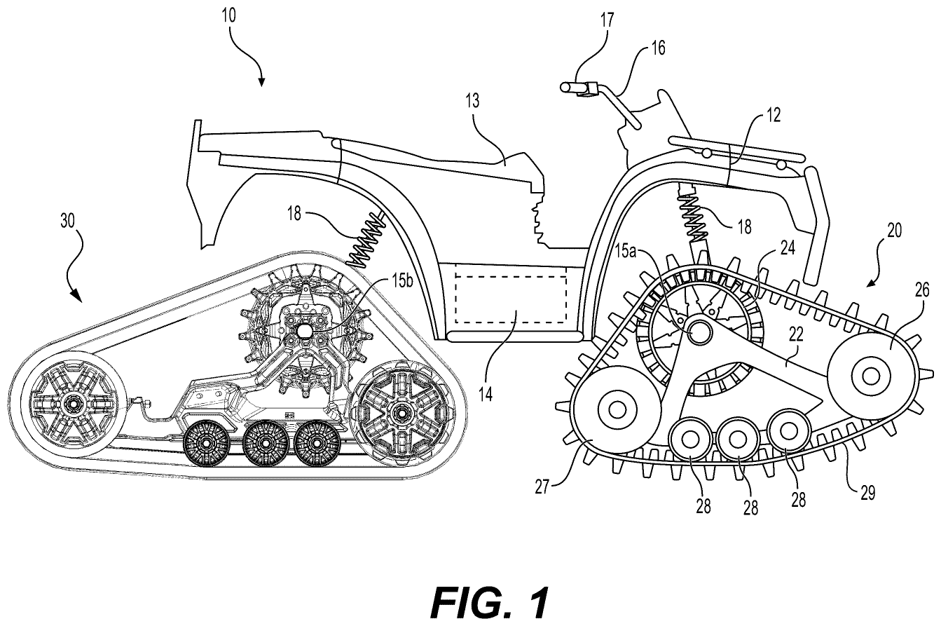

Referring to FIG. 1, the present technology will be described with reference to a vehicle 10. The vehicle 10 is an off-road vehicle 10. More precisely, the vehicle 10 is an all-terrain vehicle (ATV) 10. It is contemplated that in other embodiments, the vehicle 10 could be another type of recreational vehicle such as a snowmobile, a side-by-side vehicle or a utility-task vehicle. A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 has two front track systems 20 (only the right one being shown in FIG. 1), and two rear track systems 30 (only the right one being shown in FIG. 1) in accordance with embodiments of the present technology. It is contemplated that the vehicle 10 could have more or less than four track systems.

The vehicle 10 includes a frame 12, a straddle seat 13 disposed on the frame 12, a powertrain 14 (shown schematically), a steering system 16, suspension systems 18, and the track systems 20, 30.

The powertrain 14, which is supported by the frame 12, is configured to generate power and transmit said power to the track systems 20, 30 via driving axles, thereby driving the vehicle 10. More precisely, the front track systems 20 are operatively connected to a front axle 15a of the vehicle 10 and, the rear track systems 30 are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20, 30 may be operatively connected to non-driven axle of unpowered vehicles (e.g., trailer). In yet other embodiments, the vehicle 10 could have more than two axles. For example, the vehicle 10 may be provided with a front axle, an intermediate axle and a rear axle, all or some of which could be operatively connected to the powertrain 14.

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20 relative to the frame 12 is changed, thereby enabling the vehicle 10 to turn in a desired direction. Other steering systems 16 are contemplated.

The suspension systems 18, which are connected between the frame 12 and the track systems 20, 30, allow relative motion between the frame 12 and the track systems 20, 30. The suspension systems 18 can enhance handling of the vehicle 10 by absorbing shocks and assisting in maintaining adequate traction between the track systems 20, 30 and the ground.

The track systems 20, 30 are configured to compensate for and/or otherwise adapt to the suspension systems 18 of the vehicle 10. For instance, the track systems 20, 30 are configured to compensate for and/or otherwise adapt to alignment settings, namely camber (i.e., a camber angle, “roll”), caster (i.e., a caster angle, “steering angle” and/or toe (i.e., a toe angle, “yaw”), which may be implemented by the suspension systems 18. As the vehicle 10 could have been originally designed to use wheels instead of the track systems, the alignment settings could originally have been set to optimize travel, handling, ride quality, etc. of the vehicle 10 with the use of wheels. Since the track systems 20, 30 are structurally different and behave differently from wheels, the track system 20, 30 may be configured to compensate for and/or otherwise adapt to the alignment settings to enhance their traction and/or other aspects of their performances and/or use.

Still referring to FIG. 1, each of the front track systems 20 includes a frame 22, a drive wheel assembly 24, a front idler wheel assembly 26, a rear idler wheel assembly 27, support wheel assemblies 28 and an endless track 29. The drive wheel assembly 24, the front and rear idler wheel assemblies 26, 27 and the support wheel assemblies 28 are rotationally connected to the frame 22. The endless track 29 surrounds the drive wheel assembly 24, the front and rear idler wheel assemblies 26, 27 and the support wheel assemblies 28.

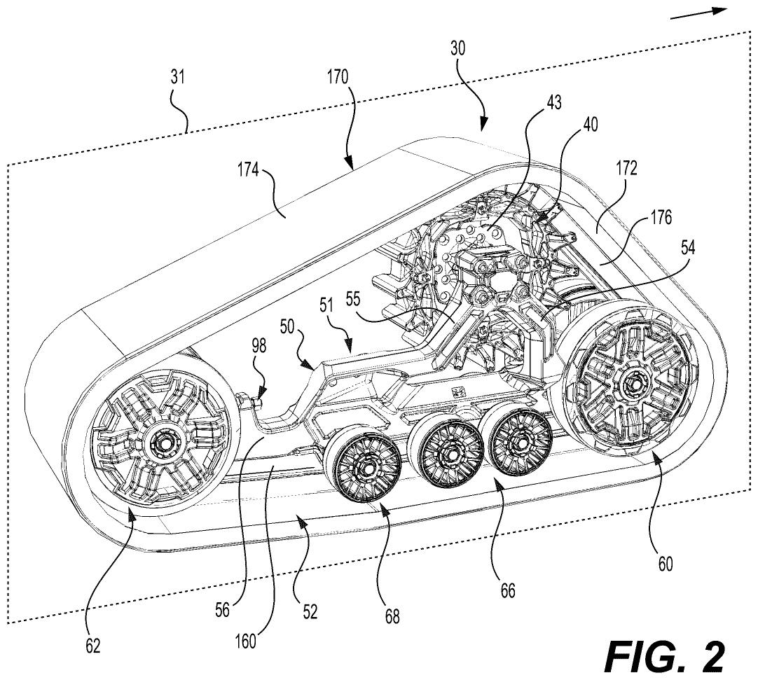

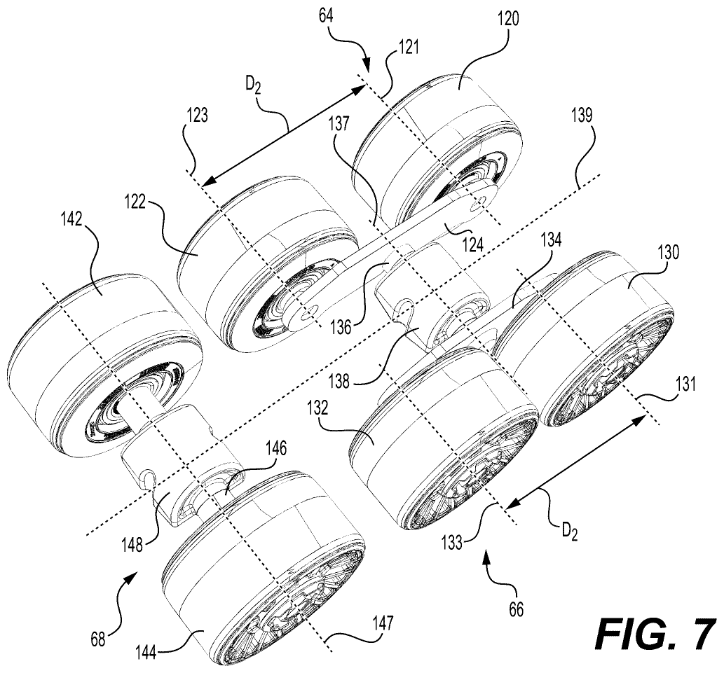

Referring now to FIGS. 2 to 7, the rear track systems 30 will now be described in greater detail. Since the left and right rear track systems 30 are similar, only the rear right track system 30, simply referred to as track system 30, will be described herewith.

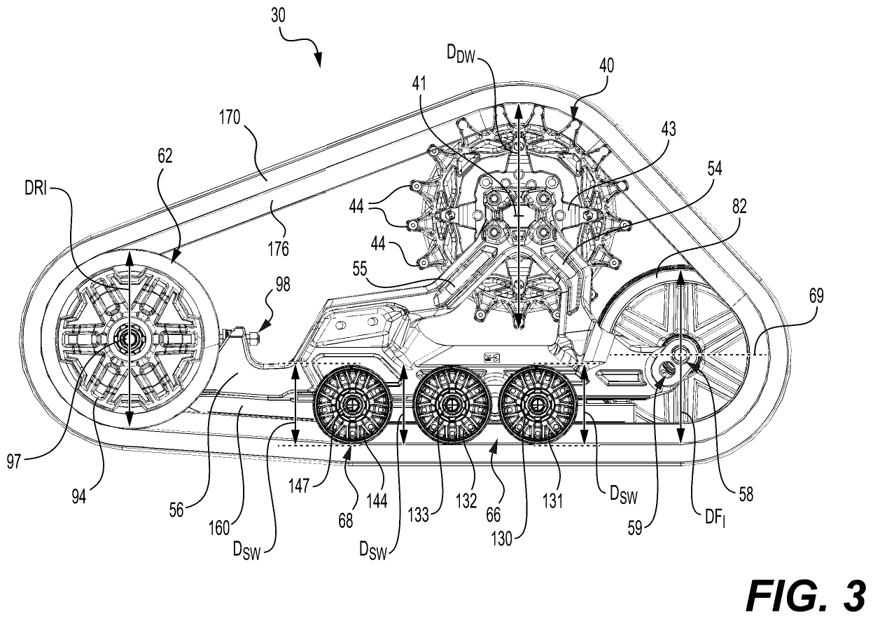

The track system 30 includes a drive wheel assembly 40, which may sometimes be referred to as a sprocket wheel assembly. The drive wheel assembly 40 is operatively connected to the driving axle 15b such that in response to the driving axle 15b rotating, the drive wheel assembly 40 also rotates about a drive wheel axis 41 (FIG. 3). Rotation of the drive wheel assembly 40 can drive the track system 30. The drive wheel assembly 40 includes a drive wheel 42 and a spindle 43. The spindle 43 connects the drive wheel 42 to a frame 50 of the track system 30. The drive wheel 42 has a drive wheel diameter D_{DW}. The drive wheel 42 has engaging members 44 (i.e., teeth) disposed on the circumference thereof. The engaging members 44 are adapted to engage with lugs 176 provided on an inner surface 172 of an endless track 170 of the track system 30. It is contemplated that in other embodiments, the configuration of the drive wheel assembly 40, and thus the manner in which the drive wheel assembly 40 engages with the endless track 170 could differ without departing from the scope of the present technology.

The track system 30 further includes the frame 50. The frame 50 defines an inner lateral side 51 and an outer lateral side 52, with the inner lateral side 51 being closer to the vehicle 10 than the outer lateral side 52. The inner and outer lateral sides 51, 52 are defined consistently with inner and outer sides of a longitudinal center plane 31 of the track system 30. In the present embodiment, part of the frame 50 extends along the longitudinal center plane 31. In some embodiments, the longitudinal center plane 31 can be defined by part of the frame 50.

The frame 50 includes a leading frame member 54, a trailing frame member 55 and a lower frame member 56. The leading and trailing frame members 54, 55 are jointly connected around the driving axle 15b, the joint connection being positioned laterally outwardly from the drive wheel assembly 40. The leading frame member 54 extends forwardly and downwardly from the joint connection and connects to a forward portion of the lower frame member 56. The trailing frame member 55 extends rearwardly and downwardly from the joint connection and connects to a rearward portion of the lower frame member 56. The lower frame member 56, which is positioned below the joint connection, extends generally parallel to the forward direction of travel of the vehicle 10. In the present embodiment, the leading, trailing and lower frame members 54, 55, 56 are integral. It is contemplated that in other embodiments, the leading, trailing and lower frame members 54, 55, 56 could be distinct members connected to one another.

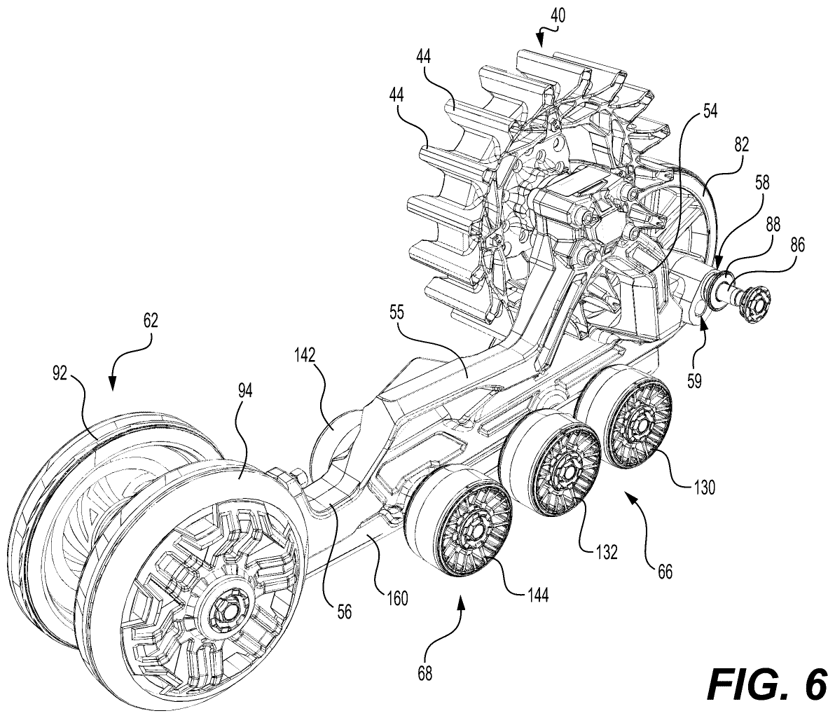

Seen in FIG. 6, the frame 50 defines, at a front end of the lower frame member 56, an upper mounting aperture 58 and a lower mounting aperture 59. It is contemplated that in other embodiments, the frame 50 may define only a single mounting aperture or three or more mounting apertures. The upper mounting aperture 58 is positioned vertically higher than the lower mounting aperture 59. The upper mounting aperture 58 is also positioned longitudinally forward from the lower mounting aperture 59. The upper and lower mounting apertures 58, 59 are configured to receive part of a front idler wheel assembly therein. More specifically, the positioning of the upper and lower mounting aperture 58, 59 is such that they are configured to accommodate wheels of different sizes while not modulating a layout of the track system 30. Indeed, while either of the upper and lower apertures can accommodate wheels of any size, the upper mounting aperture 58 can accommodate wheels of greater diameter than the lower mounting aperture 59 if the layout of the track system 30 shown in FIGS. 2 to 7 is to be maintained. In practice, the track system 30 can have its properties altered by changing the size of the wheels of the front idler wheel assembly 60. This may be advantageous as it is easier and faster to change the front idler wheel assembly 60 of the track system 30 as opposed to replacing the whole track system.

It is contemplated that in other embodiments, the configuration of the frame 50 could differ without departing from the scope of the present technology. For instance, it is contemplated that in some embodiments, the frame 50 could include more or less than three members. In some embodiments, one or more of the leading, trailing and lower frame members 54, 55, 56 could be pivotally connected to one another.

With continued reference to FIGS. 2 to 7, the track system 30 further includes a front idler wheel assembly 60, a rear idler wheel assembly 62, and a plurality of support wheel assemblies including: an inner tandem wheel assembly 64, an outer tandem wheel assembly 66 and a rear support wheel assembly 68. It is contemplated that in other embodiments, the track system 30 could have a different number of wheel assemblies.

The front idler wheel assembly 60 includes an inner wheel 82, an outer wheel 84, a shaft 86 and a biasing member 88. The inner wheel 82 is disposed on the inner lateral side 51, and the outer wheel 84 is disposed on the outer lateral side 52, such that the inner and outer wheels 82, 84 are laterally spaced from one another. The inner and outer wheels 82, 84 are rotationally connected to the shaft 86 via bearings (not shown), such that the inner and outer wheels 82, 84 are rotatable about an axis 87 defined by the shaft 86. The inner and outer wheels 82, 84 each define a front idler wheel diameter D_{FI}. The front idler wheel diameter D_{FI} is generally similar to the drive wheel diameter D_{DW}. It is contemplated that in some embodiments, the front idler wheel diameter D_{FI} may be smaller than the drive wheel diameter D_{DW}.

The biasing member 88 is operatively connected to the shaft 86 and to the lower frame member 56, such that the biasing member 88 enables the shaft 86 to move relative to the lower frame member 56. More specifically, the biasing member 88 surrounds the shaft 86, and the shaft 86 and the biasing member 88 are received in the upper mounting aperture 58. The biasing member 88 is resiliently deformable, such that it enables the shaft 86 and the inner and outer wheels 82, 84 to pivot about a longitudinally extending axis 69. In response to the shaft 86 and the inner and outer wheels 82, 84 being offset from a resting position (e.g., when the track system 30 is overcoming an obstacle), the biasing member 88 biases the shaft 86 and the inner and outer wheels 82, 84 back toward the resting position. In the present embodiment, the biasing member 88 is made of a resilient material such as rubber, but other biasing members are contemplated. In some embodiments, the biasing member 88 may be omitted from the front idler wheel assembly 80, such that the shaft 86 may not be pivotable about the longitudinally extending axis 69. In yet other embodiments, it is contemplated that the shaft 86 may be connected to another type of biasing member enabling pivotal motion thereof relative to the frame 50.

The rear idler wheel assembly 62 includes an inner wheel 92, an outer wheel 94, a shaft 96 and a tensioner 98. The inner wheel 92 is disposed on the inner lateral side 51, and the outer wheel 94 is disposed on the outer lateral side 52, such that the inner and outer wheels 92, 94 are laterally spaced from one another. The inner and outer wheels 92, 94 are rotationally connected to the shaft 96 via bearings (not shown), such that the inner and outer wheels 92, 94 are rotatable about an axis 97 defined by the shaft 96.

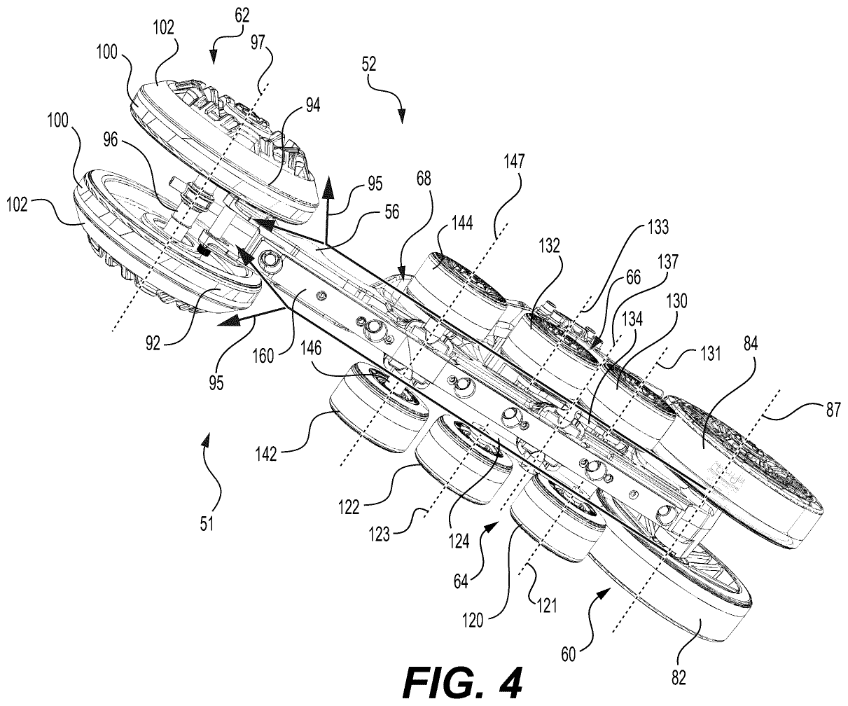

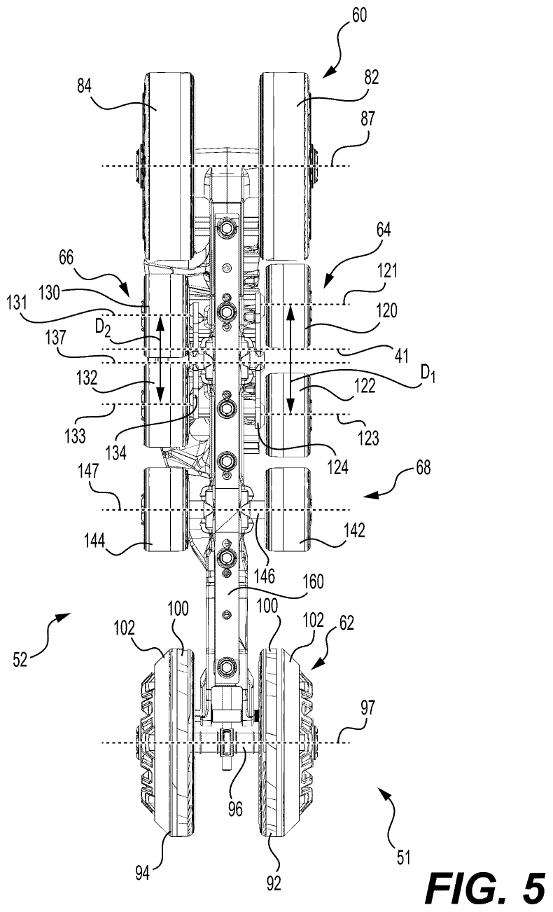

As best seen in FIGS. 4 and 5, the inner and outer wheels 92, 94 have a conical shape. More specifically, each one of the inner and outer wheels 92, 94 has a cylindrical portion 100 and a conical portion 102. For each one of the inner and outer wheels 92, 94, the cylindrical portion 100 is closer to the frame 50 (i.e., closer to the longitudinal center plane 31) than the conical portion 102.

Conventionally, wheels with relatively large widths may be used in order to distribute a load borne thereby across a larger area of an endless track 170. However, with these larger wheels, debris such as rocks, mud or ice may get “ingested” into the endless track (e.g., between lugs), which can cause problems between the engagement of the drive wheel assembly and the endless track.

In the present embodiment, the inner and outer wheels 92, 94 are relatively large in width, which distributes load borne thereby across a larger area, but the conical portions 102 can assist in, while the track system 30 is in use, reducing debris ingestion by guiding a majority of debris away from the longitudinal center plane 31 of the track system 30, as shown by schematic arrows 95 in FIG. 4. In some cases, a small amount of debris may make their way toward the longitudinal center plane 31, as also depicted by the schematic arrows 95. It is contemplated that in some embodiments, only one of the inner and outer wheels 92, 94 may have a conical shape (e.g., debris are guided away from the longitudinal center plane 31 only from the inner lateral side of the track system 30 or only from the outer lateral side of the track system 30).

The inner and outer wheels 92, 94 each define a rear idler wheel diameter D_{RI}. The rear idler wheel diameter D_{RI} is measured at the cylindrical portion 100. The rear idler wheel diameter D_{RI} is generally similar to the drive wheel diameter D_{DW} and to the front idler wheel diameter D_{FI}. It is contemplated that in some embodiments, the rear idler wheel diameter D_{RI} may be smaller than the drive wheel diameter D_{DW}. The shaft 96 is connected to the frame 50 via the tensioner 98.

The tensioner 98 is operable to move the shaft 96, and thus the inner and outer wheels 92, 94, relative to the frame 50 in order to modulate (e.g., increase or decrease) tension in the endless track 170. It is contemplated that in some embodiments, the tensioner 98 may be omitted, such that the shaft 96 may be directly connected to the frame 50. It is contemplated that in some embodiments, the rear idler wheel assembly 62 may further include a biasing member. In yet other embodiments, the tensioner 98 may be connected to the front idler wheel assembly 60.

Referring to FIGS. 4 to 7, the support wheel assemblies, which are disposed longitudinally between the front and rear idler wheel assemblies 60, 62, will now be described in greater detail.

The inner tandem wheel assembly 64 is disposed on the inner lateral side 51, the outer tandem wheel assembly 66 is disposed on the outer lateral side 52, and the rear support wheel assembly 68, which is disposed longitudinally rearward from the inner and outer tandem wheel assemblies 64, 66, extends on both the inner and outer lateral sides 51,52.

The inner tandem wheel assembly 64 includes an inner front support wheel 120, an inner intermediate support wheel 122 and an inner linkage 124. The inner front and intermediate support wheels 120, 122 are rotationally connected to the inner linkage 124, such that the inner front support wheel 120 is rotatable about an axis 121, and the inner intermediate support wheel 122 is rotatable about an axis 123.

Similarly, the outer tandem wheel assembly 66 includes an outer front support wheel 130, an outer intermediate support wheel 132 and an outer linkage 134. The outer front and intermediate support wheels 130, 132 are rotationally connected to the outer linkage 134, such that the outer front support wheel 130 is rotatable about an axis 131, and the outer intermediate support wheel 132 is rotatable about an axis 133.

The axes 121, 123, 131, 133 are longitudinally spaced from one another. It is contemplated that in some embodiments, some of the axes 121, 123, 131, 133 may be longitudinally aligned with one another. Additionally, as will be described below, the axes 121, 123, 131, 133 are also longitudinally spaced from the drive wheel axis 41. In the non-limiting illustrated embodiment, the axes 121, 123 are spaced by a distance D₁, and the axes 131, 133 are spaced by a distance D₂. The distance D₁ is greater than the distance D₂. It is contemplated that in other embodiments, the distance D₂ may be greater than the distance D₁. In is further contemplated that the distances D₁, D₂ may be equal (i.e., the axes 121, 123, 131, 133 may not be longitudinally offset from one another. In the present embodiment, the outer linkage 134 is longitudinally shorter than the inner linkage 124. It is contemplated that in other embodiments, the outer linkage 134 could be longer or the same length as the inner linkage 124, and the axes 121, 123, 131, 133 could still be longitudinally offset from one another.

The inner and outer linkages 124, 134 are rotationally connected to a shaft 136 such that the inner and outer linkages 124, 134 are rotatable about an axis 137 defined by the shaft 136. The shaft 136 is, in turn, moveably connected to the lower frame member 56 via a biasing member 138. The shaft 136 is connected to the lower frame member 56 such that the axis 137 is longitudinally offset from the drive wheel axis 41. In some embodiments, the inner and outer linkages 124, 134 could be connected to distinct shafts, such that they would be rotatable about distinct axes. The biasing member 138 enables the shaft 136 to pivot relative to the lower frame member 56 about a longitudinally extending axis 139. In response to the shaft 136 being offset from a resting position, the biasing member 138 biases the shaft 136 toward the resting position. In the present embodiment, the biasing member 138 is made of a resilient material such as rubber, but other biasing members are contemplated. Asymmetrical wheel assemblies are described in greater detail in U.S. Patent Application No. 63/467,619, the entirety of which is incorporated by reference herein.

The rear support wheel assembly 68 includes an inner wheel 142, an outer wheel 144, a shaft 146 and a biasing member 148. The inner wheel 142 is disposed on the inner lateral side 51, and the outer wheel 144 is disposed on the outer lateral side 52. The inner and outer wheels 142, 144 are rotationally connected to the shaft 146 via bearings (not shown), such that the inner and outer wheels 142, 144 are rotatable about an axis 147 defined by the shaft 146. The biasing member 148 is operatively connected to the shaft 146 and to the lower frame member 56. The biasing member 148 is resiliently deformable, such that it enables the shaft 146 and the inner and outer wheels 142, 144 to pivot about the longitudinally extending axis 139. It is contemplated that in some embodiments, the shaft 146 may pivot about an axis distinct from the axis of the inner and outer tandem wheel assemblies 64, 66. In response to the shaft 146 and the inner and outer wheels 142, 144 being offset from a resting position, the biasing member 148 biases the shaft 146 and the inner and outer wheels 142, 144 back toward the resting position. In the present embodiment, the biasing member 148 is made of a resilient material such as rubber, but other biasing members are contemplated. In some embodiments, the biasing member 148 may be omitted from the rear support wheel assembly 68, such that the shaft 146 may not be pivotable about the longitudinally extending axis 137.

It will be noted that the wheels 120, 122, 130, 132, 142, 144 all have the same diameter D_{SW}. The diameter D_{SW} is smaller than the front idler diameter D_{FI} and the rear idler diameter D_{RI}. It is contemplated that in some embodiments, the diameter D_{SW} may vary from some wheels to others. For example, in some embodiments, the inner front support wheel 120 and the outer front support wheel 130 may have a larger diameter than the other wheels 122, 132, 142, 144.

Furthermore, as best seen in FIG. 5, the support wheel assemblies 64, 66, 68 are positioned such that corresponding axes are longitudinally offset from the drive wheel axis 41. In more detail, the axis 137 is disposed longitudinally rearward from the drive wheel axis 41. The axes 121, 131 are disposed longitudinally forward from the drive wheel axis 41. The axes 123, 133 are disposed longitudinally rearward from the drive wheel axis 41. The axis 147 is disposed longitudinally rearward from the drive wheel axis 41. It is contemplated that the positioning of the axes 121, 123, 131, 133, 137, 147 may vary from one embodiment to another. For example, in one embodiment, the axis 137 may be disposed longitudinally forward from the drive wheel axis 41 and/or the axis 133 may be disposed longitudinally forward from the drive wheel axis 41.

The track system 30 also includes a guide rail 160. The guide rail 160 is connected to the frame 50. More specifically, the guide rail 160 is connected to an underside of the lower frame member 56. In some embodiments, the guide rail 160 may be connected to the lower frame member 56 by a support structure. The guide rail 160 is positioned and configured such that when the track system 30 is in a resting state, a bottom of the guide rail 160 is spaced from the inner surface 172 of the endless track 170. The guide rail 160 is resiliently deformable, and can assist in limiting deformation of the endless track 170 (e.g., in a vertical direction), while also assisting in guiding the support wheel assemblies 64, 66, 68 and guiding the endless track 170, which can reduce likelihood of the endless track 170 from detracking. The guide rail 160 is made from a material having a low coefficient of friction with the endless track 70, such as ultra-high molecular weight polyethylene (UHMW-PE). The guide rail is described in greater detail in U.S. Patent Application No. 63/537,251, the entirety of which is incorporated by reference herewith.

With reference to FIGS. 2 and 3, the endless track 170 of the track system 30 will now be described in greater detail. The endless track 170 extends around components of the track system 30, notably the frame 50, the front and rear idler wheel assemblies 60, 62 and the plurality of support wheel assemblies 64, 66, 68.

The endless track 170 has the inner surface 172 and an outer surface 174. The inner surface 172 of endless track 170 has the lugs 176. There is a single set of longitudinally spaced lugs 176. The lugs 176 are adapted to engage with the engaging members 44 of the drive wheel assembly 40. It is contemplated that in some embodiments, there could be two or more sets of longitudinally spaced lugs 176.

The outer surface 174 of the endless track 170 has a tread (not shown) defined thereon. It is contemplated that the tread could vary from one embodiment to another. In some embodiments, the tread could depend on the type of vehicle on which the track system 30 is to be used and/or the type of ground surface on which the vehicle 10 is destined to travel. In the present embodiment, the endless track 170 is an endless polymeric track. It is contemplated that in some embodiments, the endless track 170 could be constructed of a wide variety of materials and structures.

As mentioned above, and as best seen in FIG. 3, the drive wheel diameter D_{DW}, the front idler wheel diameter D_{FI} and the rear idler wheel diameter D_{RI} are all similar in size. It is contemplated that in some instances, a ratio of the front idler wheel diameter D_{FI} over the drive wheel diameter D_{DW} is between about 0.8 and 1.2. It is also contemplated that in some embodiments, a ratio of the rear idler wheel diameter D_{RI} over the drive wheel diameter D_{DW} is between about 0.8 and 1.2. It is further contemplated that in some embodiments, a ratio of the rear idler wheel diameter D_{RI} over the front idler wheel diameter D_{FI} is between about 0.8 and 1.2. This can assist in reducing stresses in the endless track 170. Indeed, the endless track 170 curves at four points: around the drive wheel assembly 40, around the front idler wheel assembly 60, around the rear support wheel assembly 68 and around the rear idler wheel assembly 62. At three of the four points, the radii of curvature of the endless track 170 is generally similar, which can reduce hysteresis in the endless track 170, and therefore reduce rolling resistance induced by the endless track 170.

It is to be noted that in the present embodiment, each one of the front and rear idler wheel assemblies 60, 62 and each one of the support wheel assemblies 64, 66, 68 includes two laterally spaced wheels. It is contemplated however, that in some embodiments, each one of the front and rear idler wheel assemblies 60, 62 and each one of the support wheel assemblies 64, 66, 68 may only include a single wheel in the lateral direction.

A description of the track system 30 in different configurations, while disposed on a generally hard flat level surface S, such as asphalt, will now be provided.

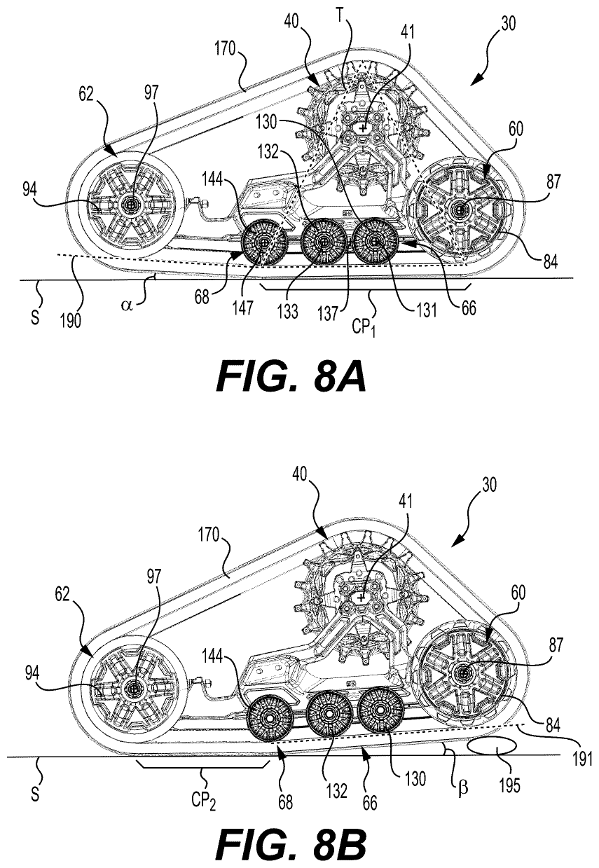

Referring to FIG. 8A, the track system 30 is in a first configuration, which may be referred to as a default configuration. That is, at rest, or while travelling at a constant speed, the track system 30 may be in this configuration. In this configuration, bottoms of the inner and outer wheels 82, 84 of the front idler wheel assembly 60, bottoms of the inner front and intermediate support wheels 120, 122 of the inner tandem wheel assembly 64 (not seen in FIG. 8A), bottoms of the outer front and intermediate support wheels 130, 132 of the outer tandem wheel assembly 66, and bottoms of the inner and outer wheels 142, 144 of the rear support wheel assembly 68 are all generally aligned with one another, whereas bottoms of the inner and outer wheels 92, 94 of the rear idler wheel assembly 62 are vertically higher than the bottoms of the other wheels (i.e., the rear idler wheel assembly 62 is elevated relative to the front idler wheel assembly 60, and to the support wheel assemblies 64, 66, 68).

In this configuration, the endless track 170 defines a first contact patch CPI that generally extends laterally along a width of the endless track 170 and longitudinally between the bottoms of the wheels 142, 144 and the bottoms of the wheels 82, 84. A length of the first contact patch CP₁ corresponds to one side of a triangle T. The triangle T is defined, as seen in FIG. 8A, between a bottom of the front idler wheel assembly 60, a bottom of rear support wheel assembly 68 and a top of the drive wheel assembly 40. This triangular relationship, results in the first contact patch CP₁ extending longitudinally forward and longitudinally rearward from the drive wheel axis 41. The triangular relationship generally defines an isosceles triangle. Thus, the triangular relationship is generally symmetrical about a laterally extending vertical plane that passes through the drive wheel axis 41. This can assist in effectively and generally equally distributing load borne by the driving axle 15b on either longitudinal side thereof. This can assist in extending life of the endless track 170 as well as life of the front idler wheel assembly 60, and the support wheel assemblies 64, 66, 68.

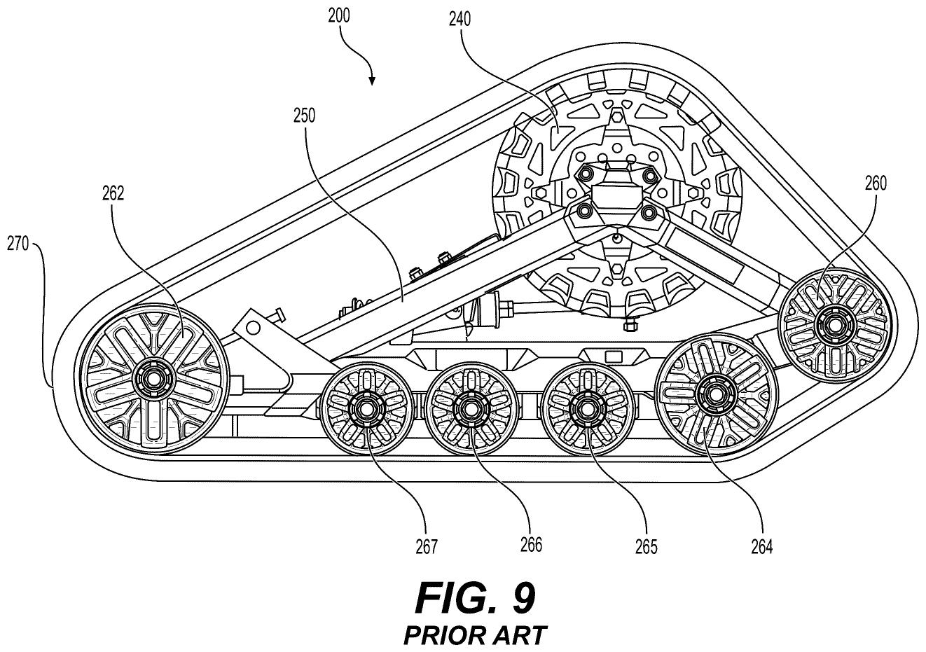

Additionally, the track system 30 does not define an approach angle, as is customary in conventional track systems, as shown in the conventional track system 200 in FIG. 9. The conventional track system 200 is described in greater detail in U.S. patent application Ser. No. 18/136,650, the entirety of which is incorporated by reference herewith. The conventional track system 200 includes a frame 250, a drive wheel assembly 240, a front idler wheel assembly 260, a rear support wheel assembly 262, and support wheel assemblies 264, 265, 266, 267.

Referring back to FIG. 8A, the track system 30 does, however, define a departure angle α, unlike conventional track systems. The departure angle α is defined between the hard flat surface S and a section of the endless track 170, where the section of the endless track 170 is generally parallel to a line 190 extending between the bottoms of the wheels 142, 144 and the bottoms of the wheels 92, 94.

When the track system 30 is in the first configuration and is moving on the hard flat surface S, the track system 30 can overcome obstacles despite the absence of the approach angle due to the large size of the front idler wheel assembly 60. It can thus be said that the front idler wheel diameter D_{FI} being relatively large can alleviate, at least to some extent, the absence of an approach angle. It will be appreciated that the presence of the departure angle α, along with the rear idler wheel diameter D_{RI} being relatively large, combine to further facilitate overcoming obstacles when the vehicle 10 is reversing (i.e., the departure angle α becomes an approach angle).

Additionally, since the rear idler wheel assembly 62 is elevated, the endless track 170 is subjected to less wear, as it has a smaller contact patch when compared to the conventional track system 200. The smaller contact patch CP₁ can also assist in reducing energy required to move the track system 30.

Referring to FIG. 8B, when the track system 30 is moving on the hard flat surface S, and encounters an obstacle 195, the track system 30 may move to a second configuration, which may be referred to as a climbing configuration. The track system 30 may move to the second configuration by pivoting about the rear support wheel assembly 68. The rear support wheel assembly 68 thus acts as a pivot point and can assist in providing the track system 30 with a departure angle or an approach angle, depending on the configuration of the track system 30.

In this configuration, the bottoms of the inner and outer wheels 82, 84 of the front idler wheel assembly 60, the bottoms of the inner front and intermediate support wheels 120, 122 of the inner tandem wheel assembly 64 and the bottoms of the outer front and intermediate support wheels 130, 132 of the outer tandem wheel assembly 66 are vertically higher than the bottoms of the inner and outer wheels 142, 144 of the rear support wheel assembly 68 and the bottoms of the inner and outer wheels 92, 94 of the rear idler wheel assembly 62. Additionally, the bottoms of the inner and outer wheels 142, 144 and the bottoms of the inner and outer wheels 92, 94 are generally vertically aligned with one another. Thus, in this configuration, the front idler wheel assembly 62 and the inner and outer tandem wheel assemblies 64, 66 are elevated relative to the rear idler wheel assembly 62, and relative to the rear support wheel assembly 68.

Thus, in this configuration, the endless track 170 defines a second contact patch CP₂. The second contact patch CP₂ is disposed longitudinally rearward from the drive wheel axis 41, and is smaller than the first contact patch CP₁. However, in this configuration, the front of the endless track 170 may be in contact with the obstacle 195, such that in some cases, an overall effective contact area of the endless track 170 may be in fact be increased.

In this configuration, the track system 30 defines an approach angle B. The approach angle β is defined between the hard flat surface S and a section of the endless track 170, where the section of the endless track 170 is generally parallel to a line 191 extending between the bottom of the wheels 142, 144 and the bottom of the wheels 82, 84. The presence of the approach angle β along with the larger diameter of the front idler wheel assembly 60 can facilitate overcoming of an obstacle. It will be noted that the beginning of the approach angle is provided by the rear support wheel assembly 68.

As the track system 30 is overcoming the obstacle 195, the offset of the axes 121, 123, 131, 133, 135 with the driving axis 41, along with the presence of the guide rail 160 can assist in limiting how much of the “bump” resulting from the obstacle 195 is transmitted to the vehicle 10. Thus, transmission of vibrations from the hard flat surface S to the vehicle 10 is limited, such that the track system 30 can improve ride quality.

The present layout also optimizes the track system 30 to be an all-weather/all-season track kit, such that the track system 30 is optimized for use in summer as well as for use in winter. Indeed, conventional rear track systems such as the conventional track system 200 shown in FIG. 9 usually have a large contact patch in order to enhance floatation of the conventional track system 200 (e.g., for use in snow).

This can be detrimental in summer, as a large contact patch can increases rolling resistance and can accelerate wear thereof.

In the layout of the present track system 30, the rear idler wheel assembly 62 being elevated reduces the size of the contact patch when used on hard surfaces (usually in summer). As a result, rolling resistance is reduced, and a rate of wear of components of the track system is reduced.

However, when used on softer surfaces, such as snow (in winter) for example, the track system 30 can partially sink into the snow, which results in at least part of the endless track 170 extending between the rear idler wheel assembly 62 and the rear support wheel assembly 68 engaging with the snow, thereby increasing size of the contact patch. The increase in size of the contact patch can enhance floatation, which would in this scenario be desired.

Also, in some instances, when the conventional track system 200 is used on snow, snow can be pushed in a rearward direction by the endless track 270, thereby causing slippage of the conventional track system 200 (as snow compaction below the track system 200 is not equal).

However, when the track system 30 is used in snow, and with the track system 30 being in the second configuration, while snow is pushed in the rearward direction by the endless track 170, slippage of the track system 30 is limited, inter alia, because of the layout of the track system 30. Specifically, the presence of the approach angle β that extends from the rear idler wheel assembly 38 provides space for a progressive compaction of the snow, and distribution of the load borne by the wheels also help in gradually loading the snow.

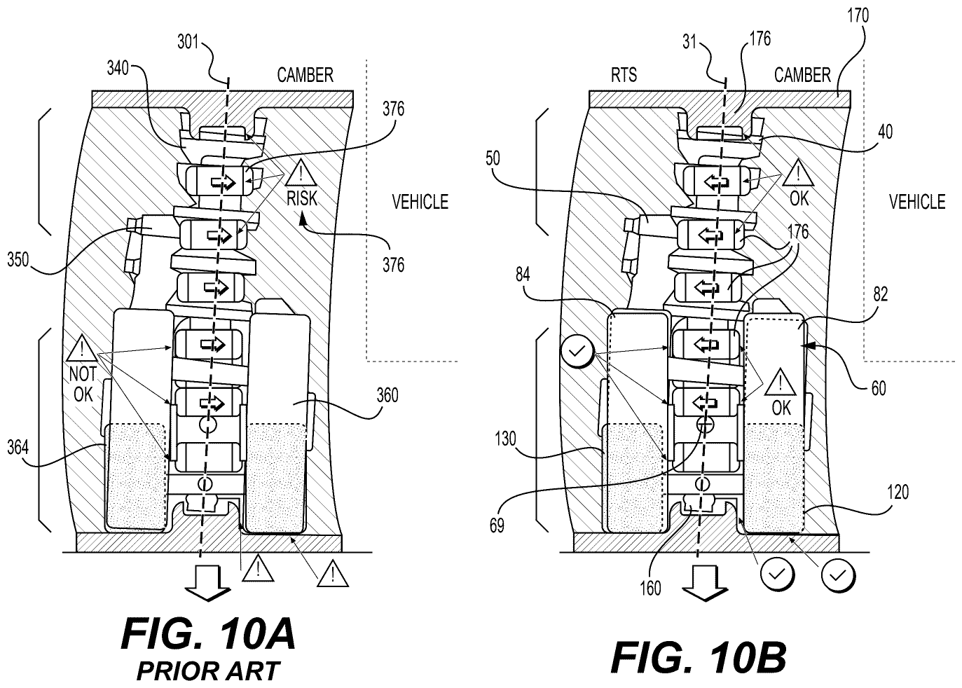

Referring to FIGS. 10A and 10B, another advantage provided by the track system 30 will be described. As mentioned above, the front idler wheel assembly 60 is pivotable about the axis 69.

In some instances, the endless track 70 may be subjected to a force oriented in the lateral direction (e.g., track system has a camber angle and/or the track system is being used on uneven terrain).

Referring to FIG. 10A, when a conventional track system 300 is connected to a vehicle with a camber angle offset from zero (i.e., either positive camber angle or negative camber angle), parts of the conventional track system 300 are at an angle relative to one another. In such a scenario, a frame 350 of the conventional track system 300, a longitudinal center plane 301 of the conventional track system 300, and a drive wheel assembly 340 of the conventional track system 300 would all be angled with respect to a vertical plane extending longitudinally. Since the front idler wheel assembly 360, like in typical conventional track systems, is not pivotable relative to the frame 350, the front idler wheel assembly 360 also follows an orientation of the camber angle.

However, a bottom of the endless track 370 and support wheel assemblies 364, which are pivotable relative to the frame 350, are generally in-line with the ground (e.g., generally horizontal).

This can subject the endless track 370 to a lateral force, causing deformation thereof, because the endless track 370 is constrained at the top by the drive wheel assembly 340 and at the bottom by the ground and the support wheel assemblies 364, at different orientations. This can result in the lugs 376 abutting against wheels of the front idler wheel assembly 360, which can cause premature wear and even cause the endless track 370 to detrack.

Referring to FIG. 10B, in the track system 30, since the front idler wheel assembly 60 is pivotable about the longitudinally extending axis 69, the front idler wheel assembly 60 pivots to be flat on the endless track 170, instead of being in-line with the frame 50. As a result, the wheels 82, 84 do not abut against the 176, which can limit wear and limit likelihood of detracking. The front idler wheel assembly 60 is pivotable because the guide rail 160 can assist in guiding the endless track 170, and because the rest of the layout can assist in limiting likelihood of the endless track 170 from detracking.

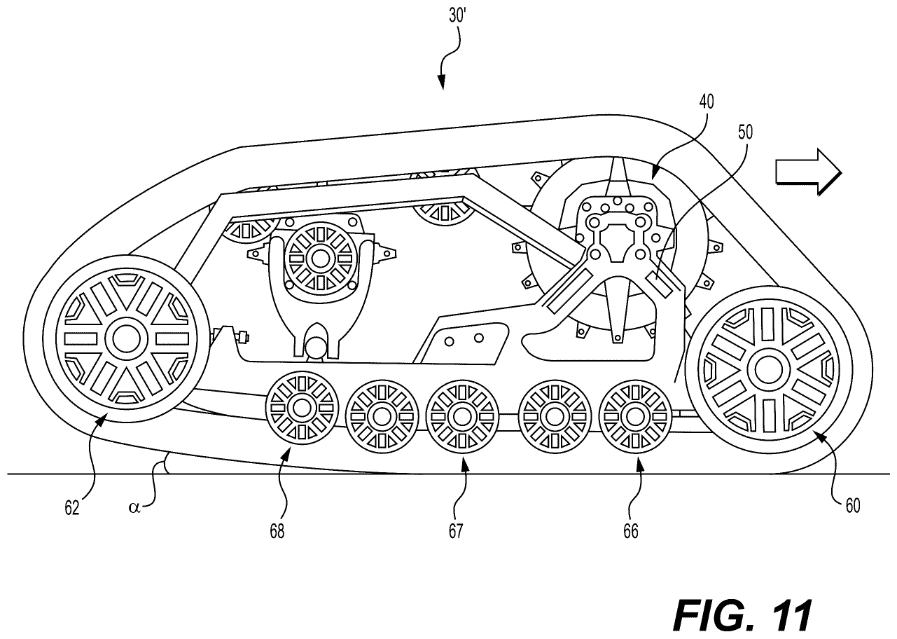

Additionally, as shown in FIG. 11, an alternative track system 30′ of the present technology is shown. The track system 30′ is configured to be connected to two driving axles (e.g., to be used with a 6×6 vehicle). Features of the track system 30′ similar to those of the track system 30 have been labeled with the same reference numerals.

The track system 30′ notably differs from the track system 30 in that the track system 30′ has four tandem wheel assembly (instead of two), with a right tandem wheel assembly 67 being shown.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A track system for a vehicle, the track system comprising:
a frame defining a first lateral side and a second lateral side;
a drive wheel assembly rotationally connected to the frame, the drive wheel assembly being rotatable about a drive wheel axis, and having a drive wheel defining a drive wheel diameter;
a front idler wheel assembly rotationally connected to the frame, the front idler wheel assembly having two laterally spaced wheels, each one of the two laterally spaced wheels being disposed on either lateral side of the frame, and each one of the two laterally spaced wheels defining a front idler wheel diameter;
a rear idler wheel assembly rotationally connected to the frame, the rear idler wheel assembly having two laterally spaced wheels, each one of the two laterally spaced wheels being disposed on either lateral side of the frame, each one of the two laterally spaced wheels defining a rear idler wheel diameter;
a plurality of support wheel assemblies including:
a first tandem wheel assembly pivotally connected to the frame, and disposed on the first lateral side of the frame, the first tandem wheel assembly including a first support wheel and a second support wheel, the first support wheel being disposed at least partially longitudinally forward from the drive wheel axis, and the second support wheel being disposed at least partially longitudinally rearward from the drive wheel axis;
a second tandem wheel assembly pivotally connected to the frame, and disposed on the second lateral side of the frame, the second tandem wheel assembly including a third support wheel and a fourth support wheel, the third support wheel being disposed at least partially longitudinally forward from the drive wheel axis, and the fourth support wheel being disposed at least partially longitudinally rearward from the drive wheel axis; and
a rear support wheel assembly rotationally connected to the frame, the rear idler wheel assembly having a fifth support wheel and a sixth support wheel, the fifth support wheel being disposed on the first lateral side of the frame, and the sixth support wheel being disposed on the second lateral side of the frame,
an endless track surrounding the frame, the drive wheel assembly, the front idler wheel assembly, the rear idler wheel assembly, and the plurality of support wheel assemblies,
the drive wheel diameter, the front idler wheel diameter and the rear idler wheel diameter being generally similar;
with the track system being in a first configuration on a hard flat level surface:
a bottom of the first support wheel, a bottom of the second support wheel, a bottom of the third support wheel, a bottom of the fourth support wheel, a bottom of the fifth support wheel, a bottom of the sixth support wheel, and bottoms of the laterally spaced wheels of the front idler wheel assembly are generally vertically aligned; and
bottoms of the laterally spaced wheels of the rear idler wheel assembly are vertically higher than the bottom of the first support wheel, the bottom of the second support wheel, the bottom of the third support wheel, the bottom of the fourth support wheel, the bottom of the fifth support wheel, the bottom of the sixth support wheel, and the bottoms of the laterally spaced wheels of the front idler wheel assembly.

2. The track system of claim 1, wherein, with the track system being in the first configuration on the hard flat level surface, the track system has a first contact patch:
a length of the first contact patch generally extending between the bottoms of the fifth and sixth support wheels and the bottoms of the laterally spaced wheels of the front idler wheel assembly, and the length of the first contact patch is one side of a triangle, the triangle being defined between:
the bottom of the laterally spaced wheels of the front idler wheel assembly,
the bottom of the fifth and sixth support wheels of the rear support wheel assembly, and
a top of the drive wheel assembly.

3. The track system of claim 2, wherein the top of the drive wheel assembly is generally longitudinally centered between the bottom of the laterally spaced wheels of the front idler wheel assembly and the bottom of the fifth and sixth support wheels of the rear support wheel assembly.

4. The track system of claim 1, wherein, with the track system being in the first configuration on the hard flat level surface, the track system has a departure angle defined between the hard flat level surface and a section of the endless track, the section of the endless track extending generally parallel to a line extending between the bottom of the laterally spaced wheels of the rear idler wheel assembly and the bottom of the laterally spaced wheels of the rear support wheel assembly.

5. The track system of claim 1, wherein, in response to the track system encountering an obstacle, the track system is pivotable about the rear support wheel assembly to a second configuration, in which:
the bottoms of the laterally spaced wheels of the rear idler wheel assembly are vertically aligned with the bottoms of the fifth and sixth wheels of the rear support wheel assembly; and
the bottom of the first support wheel, the bottom of the second support wheel, the bottom of the third support wheel, the bottom of the fourth support wheel and the bottoms of the laterally spaced wheels of the front idler wheel assembly are vertically higher than the bottoms of the laterally spaced wheels of the rear idler wheel assembly and the bottoms of the fifth and sixth wheels of the rear support wheel assembly.

6. The track system of claim 5, wherein, with the track system being in the second configuration, the track system has an approach angle defined between the hard flat level surface and a section of the endless track, the section of the endless track extending generally parallel to a line extending between the bottoms of the fifth and sixth wheels of the rear support wheel assembly and the laterally spaced wheels of the front idler wheel assembly.

7. The track system of claim 1, wherein at least one of the front idler wheel assembly and the rear idler wheel assembly is resiliently pivotable with respect to the frame about a longitudinal axis, such that in response to the at least one of the front idler wheel assembly and the rear idler wheel assembly being offset from a given position, the at least one of the front idler wheel assembly and the rear idler wheel assembly being biased toward the given position.

8. The track system of claim 1, wherein the front idler wheel diameter is equal to the rear idler wheel diameter.

9. The track system of claim 1, wherein a ratio between one of the front idler wheel diameter and the rear idler wheel diameter over the drive wheel diameter is between about 0. 8 and 1.2.

10. The track system of claim 1, wherein the endless track defines:
a first radius of curvature around the drive wheel assembly;
a second radius of curvature around the front idler wheel assembly; and
a third radius of curvature around the rear idler wheel assembly,
the first radius of curvature, the second radius of curvature and the third radius of curvature are generally similar.

11. The track system of claim 1, wherein, at least one of the two laterally spaced wheels of the rear idler wheel assembly is a conical wheel.

12. The track system of claim 1, wherein the first tandem wheel assembly and the second tandem wheel assemblies are asymmetrical.

13. The track system of claim 12, wherein:
the first support wheel and the second support wheel are longitudinally spaced by a first distance;
the third support wheel and the fourth support wheel are longitudinally spaced by a second distance; and
the first distance is greater than the second distance.

14. The track system of claim 1, wherein the first tandem wheel assembly and the second tandem wheel assembly are at least indirectly connected to one another via a shaft, and the first tandem wheel assembly and the second tandem wheel assembly are pivotable about the shaft.

15. The track system of claim 1, wherein the frame defines:
a first aperture configured to receive a shaft of the front idler wheel assembly, and
a second aperture vertically spaced from the first aperture, the second aperture being configured to receive a shaft of an alternative front idler wheel assembly, the front alternative wheel assembly comprising two laterally spaced wheels, each one of the two laterally spaced wheels defining an alternative front idler wheel diameter, the alternative front idler wheel diameter being smaller than the front idler wheel diameter.

16. The track system of claim 1, wherein the track system is an all-season track system.

17. The track system of claim 1, wherein the track system is configured to connect to one of a 4×4 vehicle, and a 6×6 vehicle.

18. A track system for a vehicle, the track system comprising:
a frame;
a drive wheel assembly rotationally connected to the frame;
at least one idler wheel assembly pivotably connected to the frame, the at least one idler wheel assembly being pivotable about a longitudinal axis;
a plurality of support wheel assemblies rotationally connected to the frame; and
an endless track surrounding the drive wheel assembly, the at least one idler wheel assembly and the plurality of support wheel assemblies.

19. The track system of claim 18, with the track system being in a first configuration on a hard flat level surface, in which the frame has a camber angle offset from zero degrees, the at least one idler wheel assembly is pivotable relative to the frame so that a rotation axis of the at least one idler wheel assembly is generally parallel to the hard flat level surface.

20. A track system for a vehicle, the track system comprising:
a frame;
a drive wheel assembly rotationally connected to the frame;
a plurality of support wheel assemblies rotationally connected to the frame;
a rear idler wheel assembly rotationally connected to the frame, the rear idler wheel assembly including at least one conical wheel; and
an endless track surrounding the drive wheel assembly. the plurality of support wheel assemblies and the rear idler wheel assembly.
